(19) United States
(12) Patent Application Publication
(10) Pub. No.: US 2026/0204976 A1
(43) Pub. Date: Jul. 16, 2026

(54) POWER DRIVE UNIT FOR A VEHICLE

(71) Applicant: Ford Global Technologies, LLC, Dearborn, MI (US)

(72) Inventors: Romi Patel, Canton, MI (US); Brian Christian Orr, Macomb, MI (US)

(73) Assignee: Ford Global Technologies, LLC, Dearborn, MI (US)

(21) Appl. No.: 19/016,627

(22) Filed: Jan. 10, 2025

(51) Int. Cl. H02K 5/06; H02K 7/116

(52) U.S. Cl. CPC H02K 5/06; H02K 7/116

(57) ABSTRACT

A power drive unit for a vehicle includes a monolithic housing defining a cavity that is configured to house components. The monolithic housing includes a body, a plurality of protrusions, and at least one rib. The plurality of protrusions are spaced apart from each other and protrude away from the cavity of the body. The rib protrudes from the body and extends between two protrusions of the plurality of protrusions.

### FIELD

The present disclosure relates to a power drive unit for a vehicle.

### BACKGROUND

The statements in this section merely provide background information related to the present disclosure and may not constitute prior art.

A power drive unit (e.g., engine or transmission) of a vehicle may be subject to vibrations and noise from internal components such as an electric motor or a gear set. Such vibrations and noise may radiate through the housing to other parts of the vehicle. Features may be added to the power drive unit to reduce the noise and vibrations emanating from the internal components. However, such features may add to the complexity of the power drive unit and affect the manufacturing thereof.

The teachings of the present disclosure address these and other issues with power drive units in vehicles.

### SUMMARY

This section provides a general summary of the disclosure and is not a comprehensive disclosure of its full scope or all of its features.

In one form, the present disclosure provides a power drive unit for a vehicle including a monolithic housing defining a cavity that is configured to house components. The monolithic housing includes a body, a plurality of protrusions, and at least one rib. The plurality of protrusions are spaced apart from each other and protrude away from the cavity of the body. The rib protrudes from the body and extends between two protrusions of the plurality of protrusions.

In variations of the power drive unit of the above paragraph, which can be implemented individually or in any combination: the rib connects the two protrusions of the plurality of protrusions; the rib extends in a different direction then the two protrusions of the plurality of protrusions; the rib includes two ribs, the two ribs intersect with each other at a location between the two protrusions of the plurality of protrusions; the plurality of protrusions are disposed at regular intervals around the body; each protrusion of the plurality protrusions has a C-or d cross-section; each rib of the plurality of ribs cooperates with the body to form a T-shaped cross-section; the components include gears that are spaced apart from the body; the two protrusions of the plurality of protrusions have different lengths; the rib protrudes away from the cavity of the body; and the rib extends across the two protrusions of the plurality of protrusions.

In another form, the present disclosure provides a power drive unit for a vehicle including a monolithic housing defining a cavity that is configured to house components. The monolithic housing includes a body, a plurality of bump structures, and at least one rib. The body includes a first portion configured to housing a first set of the components and a second portion configured to house a second set of the components. The second portion of the body extends further outward in a radial direction than the first portion of the body. The plurality of bump structures are spaced apart from each other along the second portion of the body and protrude away from the cavity of the body. The rib protrudes from the body and extends between two bump structures of the plurality of bump structures.

In variations of the power drive unit of the above paragraph, which can be implemented individually or in any combination: each bump structure of the plurality of bump structures has a C-shaped cross-section; the plurality of ribs and the body cooperate to form a T-shaped cross-section; the rib extends from the first portion of the body to the second portion of the body; the rib extends across two bump structures of the plurality of bump structures; the rib connects the two bump structures of the plurality of bump structures; the rib extends in a different direction then the two bump structures of the plurality of bump structures; and the first set of the components contacts the first portion of the body and the second set of the components is spaced apart from the second portion of the body.

In yet another form, the present disclosure provides a power drive unit for a vehicle including a first monolithic housing, power unit components; and a second housing. The first monolithic housing defines a cavity configured to house the components. The first monolithic housing includes a body, a plurality of bump structures, and a plurality of ribs. The body includes a first portion and a second portion. The second portion of the body extends further outward in a radial direction than the first portion of the body. The second portion of the body is located proximate an opening where power unit components are inserted into the cavity. The plurality of bump structures are spaced apart from each other along the second portion of the body and protrude away from the cavity of the body. At least one rib of the plurality of ribs protrudes from the body and extends between two bump structures of the plurality of bump structures. The power unit components are disposed within the body and includes a first set of components housed within the first portion of the body and a second set of components housed within the second portion of the body. The first set of components contacts the first portion of the body and the second set of components is spaced apart from the second portion of the body. The second housing is coupled to the first monolithic housing at the second portion of the body to cover the opening. Each bump structure of the plurality of bump structures has a C-shaped cross-section.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a vehicle including a battery pack and power drive units according to the principles of the present disclosure;

FIG. 2 is a cross-sectional view of one of the power drive units of the vehicle of FIG. 1;

FIG. 3 is a perspective view of a housing of one of the power drive units of FIG. 1 with the internal components removed for clarity;

FIG. 4 is another perspective view of the housing of the power drive unit of FIG. 1 with the internal components removed for clarity;

FIG. 5 is another perspective view of the housing of the power drive unit of FIG. 1;

FIG. 6 is a cross-sectional view of the housing of the power drive unit of FIG. 1;

FIG. 7 is another cross-sectional of the housing of the power drive unit of FIG. 1;

FIG. 8 is a perspective view of another housing that can be incorporated into the vehicle of FIG. 1;

FIG. 9 is a perspective view of the housing of FIG. 8; and

FIG. 10 is a cross-sectional view of the housing of FIG. 8.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

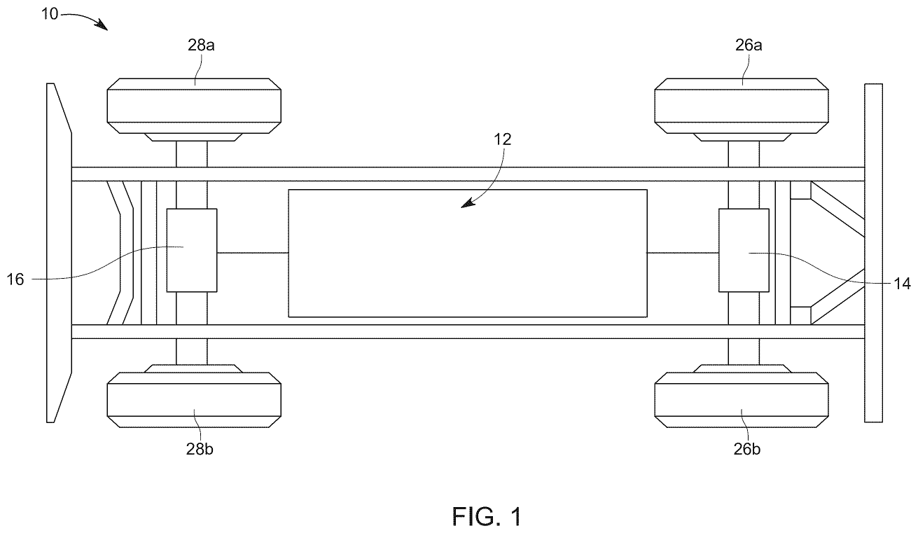

With reference to FIG. 1, a vehicle 10 such as an electric vehicle is provided. In the example provided, the electric vehicle is a battery electric vehicle (BEV). In other examples, the electric vehicle may be a hybrid electric vehicle (HEV), a plug-in electric vehicle (PHEV), or a fuel cell vehicle, among others. The vehicle 10 includes a battery pack or battery structure 12, a first power drive unit 14 such as an electric or rear motor, and a second power drive unit 16 such as an electric or front motor. The battery pack 12 may be rechargeable and may include lithium-ion batteries or any other suitable electrical power storage units. The battery pack 12 may be disposed at various locations of the vehicle 10 and may be mounted to a vehicle frame. In this way, the battery pack 12 is supported by the vehicle frame and is remote from a passenger cabin (not shown) and cargo compartments (not shown) of the vehicle 10, therefore, not occupying space that would otherwise be available for passengers or cargo. The battery pack 12 powers the first power drive unit 14 to drive a set of rear wheels 26a, 26b via a rear axle. Similarly, the battery pack 12 powers the second power drive unit 16 to selectively drive a set of front wheels 28a, 28b via a front axle. In other forms, not specifically shown, the vehicle 10 may only include the second power drive unit 16 or the first power drive unit 14. Still, in other forms, the vehicle 10 may be an internal combustion engine (ICE) vehicle where the power drive unit includes an engine and a transmission instead of an electric motor without departing from the scope of the present disclosure.

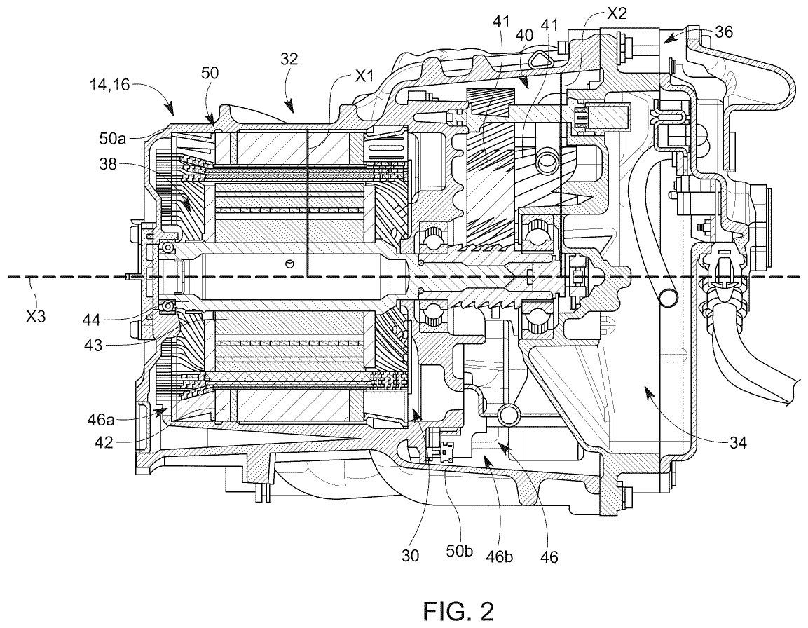

The first power drive unit 14 converts electrical energy from the battery pack 12 into mechanical power to drive the set of rear wheels 26a, 26b. With reference to FIG. 2, the first power drive unit 14 includes power unit components 30, a first housing 32, a second housing 34, and a third housing 36. The power unit components 30 are disposed within the first housing 32 and includes an electric converter 38 (first set of components) and a gear set 40 (second set of components). The electric converter 38 includes a stator 42, a rotor 43, and a shaft 44. The stator 42 is disposed within the first monolithic housing 32 such that the stator 42 contacts the first housing 32. In some forms, the stator 42 is press fit within the first housing 32. The rotor 43 is supported on the shaft 44 and is positioned inside the stator 42 so that a gap is formed between the rotor 43 and the stator 42, which is a stationary component. In this way, when current is supplied to the stator 42, a rotating magnetic field is generated causing the rotor 43 to spin within and relative to the stator 42, thereby generating torque. The shaft 44 is configured to output the torque to another component such as the gear set 40. The gear set 40 may be a gear reduction set that is configured to reduce the speed and increase the torque from the electric converter 38. The gear set 40 may include one or more gears 41 that are spaced apart from the first monolithic housing 32.

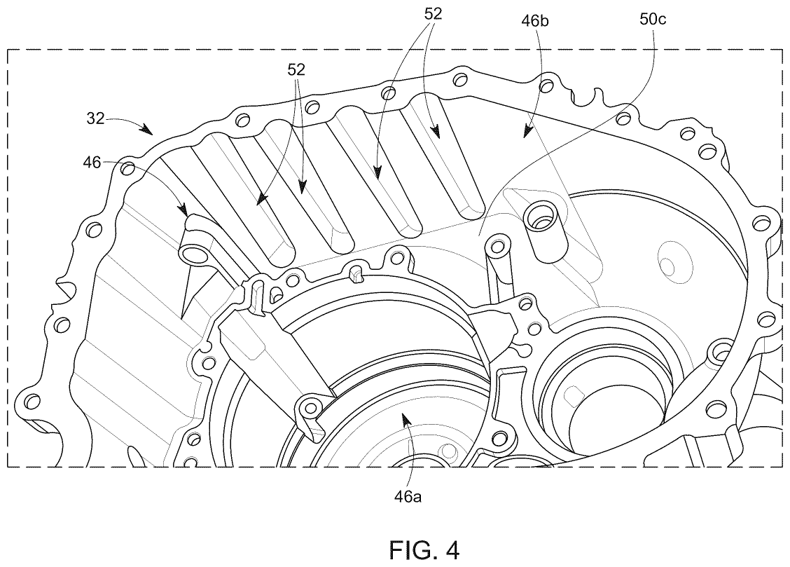

With reference to FIGS. 2-4, the first housing 32 defines a cavity 46 that houses the power unit components 30 of the first power drive unit 14. The first housing 32 may be made of a metal, plastic or composite material and may include internal grooves, surfaces, apertures that align the power unit components 30 within the first housing 32. The first housing 32 may also transfer loads from internal components to mounts (not shown) of the vehicle 10 located external to the first housing 32. The first housing 32 is in the form of a single unitized, monolithic body that can be manufactured by a casting process, for example. In some forms, the first housing 32 may be manufactured by an additive manufacturing process. The manufacturing process can include laser sintering, for example, that can generally include a laser, a means for applying subsequent layers of powdered sintering material (e.g., metal powder), and a controller that controls operation of the laser and the amount and timing of the deposition of the metal powder. It should be understood that other 3D printing/additive manufacturing methods may be employed to achieve the unitized, monolithic body, along with a variety of different materials, while remaining within the scope of the present disclosure.

The first housing 32 includes a body 50, a plurality of protrusions or bump structures 52, and a plurality of ribs 54a, 54b, 54c, 54d (together referred to as ribs 54). The body 50 includes a first portion 50a, a second portion 50b, and a connecting portion 50c that connects the first and second portions 50a, 50b. The body 50 also includes an opening 51 proximate the second portion 50b where the power unit components 30 (i.e., the electric converter 38 and the gear set 40) are inserted into the cavity 46. The second portion 50b extends further outward in a radial direction than the first portion 50a. Stated differently, the first portion 50a extends a first distance X1 (FIG. 2) from a longitudinal axis X3 (FIG. 2) of the shaft 44 of the electric converter 38 and the second portion 50b extends a second distance X2 (FIG. 2) from the longitudinal axis X3 of the shaft 44. The second distance X2 is greater than the first distance X1. In this way, the cavity 46 has a first section 46a defined by the first portion 50a of the body 50 and a second section 46b defined by the second portion 50b of the body 50 (the volume of the second section 46b is greater than the volume of the first section 46a). The first portion 50a of the body 50 houses the electric converter 38 and the second portion 50b of the body 50 that houses the gear set 40. The stator 42 of the electric converter 38 contacts or engages the first portion 50a of the body 50 (i.e., contacts an internal surface of the first portion 50a of the body 50). The gear set 40 is spaced apart from the second portion 50b of the body 50 (i.e., a gap exists between the gears and an internal surface of the second portion 50b of the body 50). The connecting portion 50c extends generally perpendicular to the first and second portions 50a, 50b.

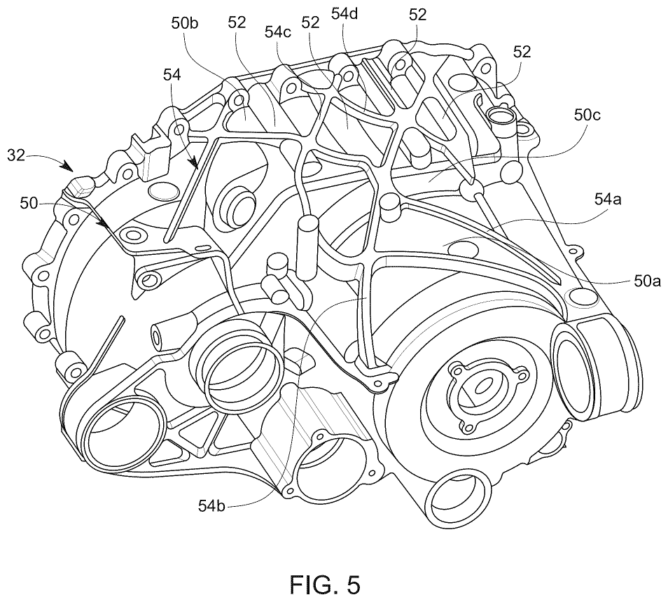

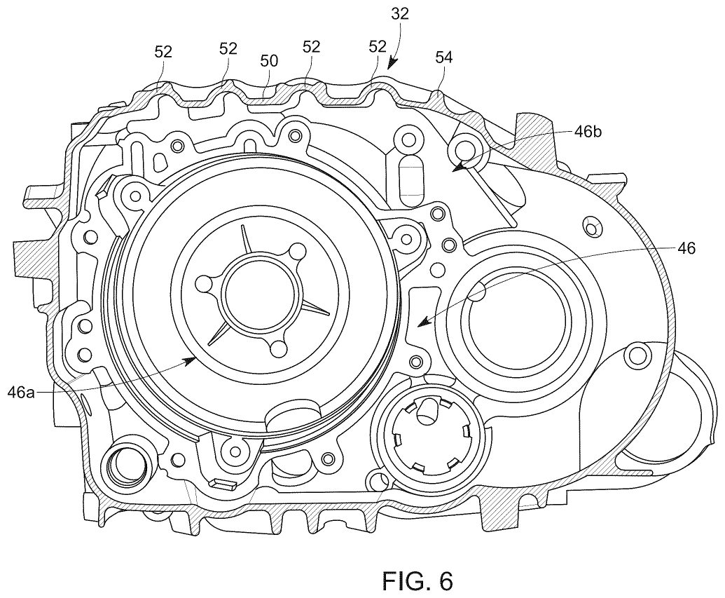

With additional reference to FIGS. 5 and 6, the plurality of protrusions 52 are spaced apart from each other and protrude from the body 50 away from the cavity 46. In the example illustrated, the protrusions 52 protrude from the second portion 50b of the body 50. In this way, the stiffness of the second portion 50b of the body 50 is enhanced to inhibit bending of the body 50 during operation of the power drive unit 14. In some forms, the protrusions 52 may also protrude from the first portion 50a of the body 50, in addition to, protruding from the second portion 50b of the body 50. In the example illustrated, each protrusion 52 has a C-shaped or U-Shaped cross-section (FIG. 6). In this way, the moment of inertia of the body 50 is enhanced without adding weight to the first housing 32.

In the example illustrated, the protrusions 52 extend in a first direction proximate the opening 51 toward the connecting portion 50c. Stated differently, the protrusions 52 are located between an end of the body 50 defining the opening 51 and the connecting portion 50c. The first direction may be generally perpendicular to the connecting portion 50c and generally parallel to the direction of the longitudinal axis X3 of the shaft 44. In the example illustrated, the protrusions 52 have different lengths. In some forms, the protrusions 52 may have the same length. In some forms, the protrusions 52 have a constant width along its length. In other forms, the protrusions 52 have a variable width along its length. In the example illustrated, the protrusions 52 are disposed at regular intervals around the body 50. In some forms, the spacing between the protrusions 52 may vary around the body 50.

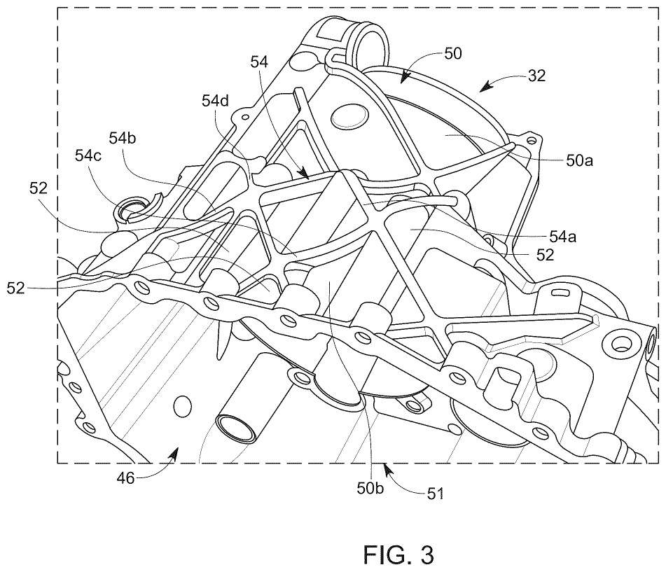

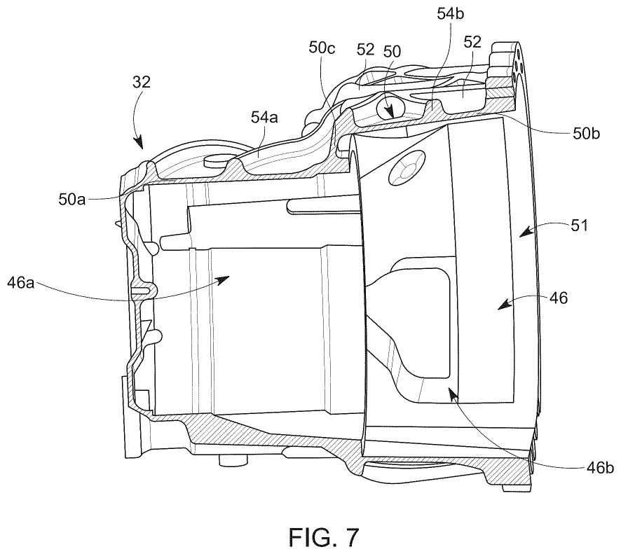

With reference to FIGS. 3, 5, and 7, the ribs 54a, 54b, 54c, 54d protrude from the body 50 away from the cavity 46. In the example illustrated, some of the ribs 54 protrude from the first and second portions 50a, 50b of the body 50 and some ribs 54 protrude from the second portion 50b of the body 50 and not the first portion 50a of the body 50. For example, the ribs 54a, 54b protrude from the first and second portions 50a, 50b of the body 50 and the ribs 54c, 54d protrude from the second portion 50b of the body 50 and not the first portion 50a of the body 50. In the example illustrated, the ribs 54 extend in a different direction than the protrusion 52. That is, the ribs 54 extend diagonal to the longitudinal axis X3 of the shaft 44 while the protrusions 52 extend parallel to the longitudinal axis X3 of the shaft 44. In the example illustrated, the ribs 54 cooperate with the body 50 to form a T-shaped cross-section (FIGS. 6 and 7).

Each rib 54 extends between two protrusions 52 of the plurality of protrusions 52. In the example illustrated, the rib 54 connects the two protrusions 52. As shown in FIGS. 3 and 5, two ribs 54 may intersect with each other between two protrusions 52, thereby forming an X-shape. That is, ribs 54a, 54c intersect with each other between two protrusions 52. Some ribs 54 intersect with each other on or at a respective protrusion 52. That is, ribs 54b, 54d intersect with each other on or at a respective protrusion 52. Still, some ribs 54 may intersect with each other at the connecting portion 50c or the first portion 50a of the body 50. Each rib 54 may also extend across one or more protrusions 52 of the housing 32. The ribs 54 enhance the stiffness of the housing 32.

The second and third housings 34, 36 are coupled to the first housing 32 at the end of the body 50 to cover the opening 51. That is, the second housing 34 is coupled to the body 50 via mechanical fasteners (e.g., bolts, screws, rivets) and the third housing 36 is coupled to the second housing 34 via mechanical fasteners (e.g., bolts, screws, rivets). In this way, the cavity 46 of the first housing 32 is sealed (i.e., fluids inside of the first housing 32 are inhibited from exiting the cavity 46 and fluids outside of the first housing 32 are inhibited from entering the cavity 46). It should be understood that the cavity 46 may include electrical and fluid conduits. The structure and function of the second power drive unit 16 may be similar or identical to the first power drive unit 14 described above, and therefore, will not be described again in detail.

The power drive units 14, 16 of the present disclosure includes the housing 32 comprising the bump structures and the ribs, which enhance the stiffness of the housing 32 without adding weight to the housing 32. In this way, the noise, vibration and harshness (NVH) of the power drive units 14, 16 are reduced during operation of the power drive units 14, 16 and manufacturing of the power drive units 14, 16 are facilitated. The predetermined pattern or layout of bump structures 52 and ribs 54 are configured to reduce the NVH of the power drive units 14, 16.

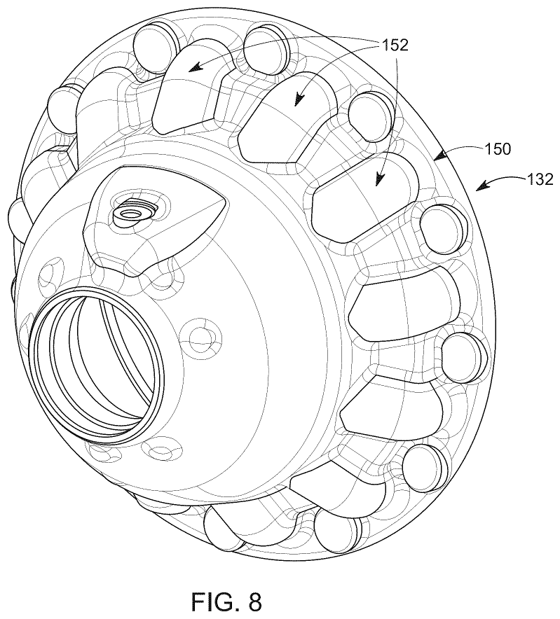

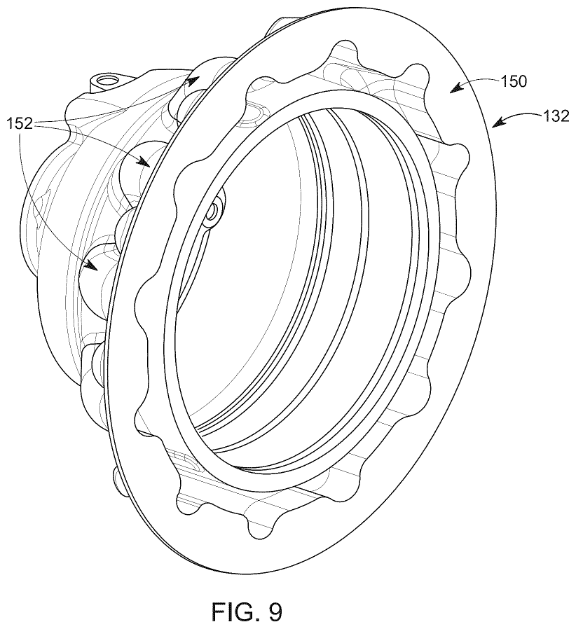

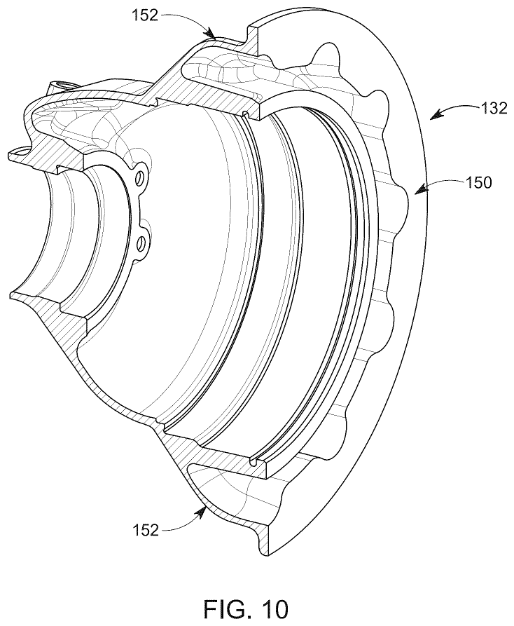

With reference to FIGS. 8-10, another housing 132 is provided. The housing 132 may be incorporated into the drive unit 14, 16 described above instead of housing 32. The structure and function of the housing 132 may be similar or identical to the housing 32 described above, expect for the differences below.

The housing 132 includes a body 150 and a plurality of protrusions or bump structures 152. The plurality of protrusions 152 are spaced apart from each other and protrude from the body 150 away from the cavity. The protrusions 150 also have a U-shaped or C-shaped cross-section and are contoured (i.e., bend, arcuate, etc.) along with the housing 132. In this way, manufacturing of the housing 132 is facilitated. As shown in the figures, the housing 132 may not include ribs.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A power drive unit for a vehicle, the power drive unit comprising:
a monolithic housing defining a cavity configured to house components, the monolithic housing comprising:
a body;
a plurality of protrusions spaced apart from each other and protruding away from the cavity of the body; and
at least one rib protruding from the body and extending between two protrusions of the plurality of protrusions.

2. The power drive unit of claim 1, wherein the at least one rib connects the two protrusions of the plurality of protrusions.

3. The power drive unit of claim 1, wherein the at least one rib extends in a different direction then the two protrusions of the plurality of protrusions.

4. The power drive unit of claim 1, wherein the at least one rib includes two ribs, and wherein the two ribs intersect with each other at a location between the two protrusions of the plurality of protrusions.

5. The power drive unit of claim 1, wherein the plurality of protrusions are disposed at regular intervals around the body.

6. The power drive unit of claim 1, wherein each protrusion of the plurality of protrusions has a C-shaped cross-section.

7. The power drive unit of claim 1, wherein each rib cooperates with the body to form a T-shaped cross-section.

8. The power drive unit of claim 1, further comprising the components, the components comprising gears that are spaced apart from the body.

9. The power drive unit of claim 1, wherein the two protrusions of the plurality of protrusions have different lengths.

10. The power drive unit of claim 1, wherein the at least one rib protrudes away from the cavity of the body.

11. The power drive unit of claim 1, wherein the at least one rib extends across the two protrusions of the plurality of protrusions.

12. A power drive unit for a vehicle, the power drive unit comprising:
a monolithic housing defining a cavity configured to house components, the monolithic housing comprising:
a body including a first portion configured to housing a first set of the components and a second portion configured to house a second set of the components, the second portion of the body extends further outward in a radial direction than the first portion of the body;
a plurality of bump structures spaced apart from each other along the second portion of the body and protruding away from the cavity of the body; and
at least one rib protruding from the body and extending between two bump structures of the plurality of bump structures.

13. The power drive unit of claim 12, wherein each bump structure of the plurality of bump structures has a C-shaped cross-section.

14. The power drive unit of claim 12, wherein the at least one rib and the body cooperate to form a T-shaped cross-section.

15. The power drive unit of claim 12, wherein the at least one rib extends from the first portion of the body to the second portion of the body.

16. The power drive unit of claim 15, wherein the at least one rib extends across two bump structures of the plurality of bump structures.

17. The power drive unit of claim 12, wherein the at least one rib connects the two bump structures of the plurality of bump structures.

18. The power drive unit of claim 12, wherein the at least one rib extends in a different direction then the two bump structures of the plurality of bump structures.

19. The power drive unit of claim 12, further comprising the first set of the components and the second set of the components, the first set of the components contacting the first portion of the body and the second set of the components spaced apart from the second portion of the body.

20. A power drive unit for a vehicle, the power drive unit comprising:
a first monolithic housing defining a cavity configured to house components, the first monolithic housing comprising:
a body including a first portion and a second portion, the second portion of the body extends further outward in a radial direction than the first portion of the body, the second portion of the body located proximate an opening where power unit components are inserted into the cavity;
a plurality of bump structures spaced apart from each other along the second portion of the body and protruding away from the cavity of the body; and
a plurality of ribs, at least one rib of the plurality of ribs protruding from the body and extending between two bump structures of the plurality of bump structures;
the power unit components disposed within the body and including a first set of components housed within the first portion of the body and a second set of components housed within the second portion of the body, the first set of components contacting the first portion of the body and the second set of components spaced apart from the second portion of the body; and
a second housing coupled to the first monolithic housing at the second portion of the body to cover the opening,
wherein each bump structure of the plurality of bump structures has a C-shaped cross-section.
